(19) United States
(12) Patent Application Publication
(10) Pub. No.: US 2018/0073105 A1
(43) Pub. Date: Mar. 15, 2018

(54) Gaphene/silver composite material and preparation method thereof

(71) Applicant: SHANGHAI HIWAVE COMPOSITE MATERIALS CO., LTD., Shanghai (CN)

(72) Inventors: Lesheng Chen, Shanghai (CN); Pengpeng Wang, Shanghai (CN); Lin Mao, Shanghai (CN); Minhua Shen, Shanghai (CN)

(21) Appl. No.: 15/559,420

(22) PCT Filed: Feb. 29, 2016
(86) PCT No.: PCT/CN2016/074798

§ 371 Date: Sep. 18, 2017

(30) Foreign Application Priority Data
Mar. 18, 2015 (CN) 201510117683.3

(51) Int. Cl. C22C 1/04; H01B 1/04; B22F 9/24; B22F 3/14; C22C 5/06; B22F 3/16; B21C 23/22; B21B 1/16

(52) U.S. Cl. CPC C22C 1/0466; H01B 1/04; B22F 9/24; B22F 3/14; C22C 5/06; B22F 2201/013; B21C 23/22; B21B 1/166; B22F 2301/255; B22F 2302/25; B22F 3/16

(57) ABSTRACT

A method for preparing graphene/silver composite material is provided. A reduction agent and silver nitrate are added successively into a graphene oxide solution; silver powder obtained by reduction is directly combined with graphene oxide in the solution, so as to preliminarily obtain graphene oxide/silver composite powder; graphene/silver composite powder is then obtained through drying and reducing; a graphene/silver composite block material, a graphene/silver composite wire material and a graphene/silver composite belt material are able to be obtained by powder metallurgy, hot-extruding and rolling techniques. According to the composite material of the present invention, graphene is dispersed uniformly, and interface bonding between a matrix and an enhanced body is sufficient, leading to excellent physical performance of the composite material. Meanwhile, the method of the present invention is simple and processes are easy to control, which is conducive to large-scale production and application.

### CROSS REFERENCE OF RELATED APPLICATION

This is a U.S. National Stage under 35 U.S.C 371 of the International Application PCT/CN2016/074798, filed Feb. 29, 2016, which claims priority under 35 U.S.C. 119(a-d) to CN 201510117683.3, filed Mar. 18, 2015.

### BACKGROUND OF THE PRESENT INVENTION

### Field of Invention

The present invention relates to a technical field of metal-based composite material and preparation technologies thereof, and more particularly to a silver-based composite material reinforced by graphene and a preparation method thereof.

### Description of Related Arts

Silver-based composite materials are conventionally the most widely used electrical contact materials. Silver lacks sufficient mechanical properties. In order to meet utilization requirements, it is conventionally widespread to combine silver with an enhanced phase such as metal oxides, so as to prepare silver-based composite materials. However, with such enhanced phase, conductivity of the silver-based composite material is decreased. Graphene is conventionally the only eco-friendly carbonaceous material which is formed by densely accumulated carbon atoms and has a two-dimensional honeycomb lattice structure. Graphene has a usual thickness of less than 10 nm and a large specific surface area (2630 m²/g). Graphene also has the highest strength ever known (up to 130 GPa), a carrier mobility of up to 150,000 cm²/V s, and a thermal conductivity of up to 5150 W(m K). Therefore, if the excellent performance of graphene can be introduced into the silver-based composite material, there will be a great impact on design and performance improvement of the silver-based composite material.

There are few international reports about graphene/metal composite material. Referring to graphene, low density, poor dispersion properties and interface reaction during melt preparation are core problems restricting the development of such composite materials. It is difficult to prepare metal-based graphene composite material by conventional methods, and only a few researchers use different methods to prepare graphene-reinforced metal-based composite materials mainly for fuel cells, catalytic materials, antibacterial materials, etc. According to Tian et al., reduced graphene oxide/silver composite material is prepared by reacting in a NaOH solution at 80° C. for 10 min. According to Kim et al., graphene-silver nanoparticle composite material with silver nanoparticle having a diameter of 2-5 nm is prepared by using hydrazine as a reduction agent in a graphene oxide aqueous solution with a stabilizer PVP and a coupling agent APTMS. According to Yuan et al., graphene nanocomposite material with 20-25 nm silver particles is prepared by using sodium citrate as reducing agent and stabilizer. It is not difficult to find that most of the preparation methods require complex synthetic steps, consume a long time, or use a large amount of toxic and hazardous reducing agent, stabilizer, etc.

Chinese patent publication CN 102385938A discloses a method for preparing a metal-based graphene composite electrical contact material with 0.02-10 wt % graphene and the balance of metal matrix by chemical reduction together with vacuum melting method. Raw materials used in the patent are graphene sheet and metal matrix prepared by chemical reduction. Molding process is vacuum melting. Compared with other composite electrical contact materials, the composite electrical contact material prepared by the method has superior electrical conductivity, thermal conductivity, hardness, wear resistance, stability, and welding resistance. However, because hazardous hydrazine hydrate is used as reducing agent, it is difficult to meet the requirements of environmental protection. Besides, during vacuum melting process, the high temperature greatly damages the graphene structure, which lowers dispersion of graphene in the matrix to some extent, thus affecting product performance.

Chinese patent publication CN 102329976A discloses a method for preparing graphene-reinforced metal-based composite material by dispersing 0.1-5 wt % graphene oxide powder on surfaces of sheet-shaped metal powder, then the graphene/metal alloy powder is obtained by reduction treatment. By using powder metallurgy techniques, graphene-reinforced metal-based composite material is obtained. The raw material used in the patent is graphene oxide, but the matrix is metal sheets (physically prepared), and the molding process is powder metallurgy. Composite material prepared by such process has a laminated structure which is conducive to orientational distribution of the graphene and exerts enhancement effect. However, the surface treatment and post-recombination process of the sheet-shaped metal are complex, while uniform recombination of graphene and metal, resulting in poor controllability of preparation process.

Therefore, preparation of high-performance graphene/silver composite material with an eco-friendly, low-cost, high-controllability method not only has important scientific value, but also has broad application prospects.

### SUMMARY OF THE PRESENT INVENTION

An object of the present invention is to provide a method for preparing graphene/silver composite material based on chemical synthesis, powder metallurgy, extruding and rolling techniques for overcoming the disadvantages of conventional technologies. The present invention uses chemical silver as matrix material and graphene as reinforcement phase, so as to prepare graphene/silver composite material with high density, electrical conductivity, hardness, tensile strength and elongation. Meanwhile, the method is simple with good process controllability, low cost, and easy-to-implement manufacture in large-scale; the graphene/silver composite material has a uniform structure and stable performance.

The present invention is realized as follows.

According to the present invention, a reduction agent and silver nitrate are added successively into a graphene oxide solution; silver powder obtained by reduction is directly composited with graphene oxide in the solution, so as to preliminarily obtain graphene oxide/silver composite powder; graphene/silver composite powder is then obtained through drying and reduction; graphene/silver composite bulk, wire and belt are obtained by powder metallurgy, hot-extruding and rolling techniques. According to the composite material of the present invention, graphene is dispersed uniformly with well bonded interface between the matrix and reinforcing agent, leading to excellent physical performance of the composite material. Meanwhile, the method of the present invention is simple and processes are easy to control, which is conducive to large-scale production and application.

Accordingly, in order to accomplish the above objects, the present invention provides a method for preparation of graphene/silver composite material, comprising steps of:

1) preparing a silver nitrate solution and a reduction agent, respectively;

2) mixing the reduction agent with a graphene oxide aqueous solution, then adding the silver nitrate solution while stirring; wherein silver nitrate is reduced to silver micro-particles and a small amount of nano-particles, and graphene oxide is adsorbed by the silver particles, so as to form a graphene oxide/silver suspension;

3) washing the graphene oxide/silver suspension obtained in the step 2) for several times by centrifugation method, then freeze-drying to obtain graphene oxide/silver composite powder;

4) preforming the graphene oxide/silver composite powder obtained in the step 3), then reducing in hydrogen to obtain graphene/silver composite powder; and

5) molding and sintering the graphene/silver composite powder obtained in the step 4) by powder metallurgy techniques, so as to obtain the graphene/silver composite material.

Preferably, the method further comprises a step 6) after the step 5): extruding the graphene/silver composite material obtained in the step 5) by hot-extruding technique and charcoal protection which prevents oxidization, wherein the material is further densified to form a graphene/silver composite wire.

Preferably, the method further comprises a step 7) after the step 6): rolling the graphene/silver composite wire obtained in the step 6) by rolling technique, so as to obtain graphene/silver composite belt, wherein the graphene is further orientation-distributed in the silver matrix, which improves the reinforcement effect of graphene.

Preferably, in the step 1), the reduction agent is selected from a group consisting of ascorbic acid, glucose, citric acid and oxalic acid.

Preferably, in the step 2), the graphene oxide is single-layer or few-layer graphene oxide prepared by a Hummers method; the mixing order of the graphene oxide aqueous solution, the reduction agent and the silver nitrate solution is: mixing the graphene oxide aqueous solution with the reduction agent, then mixing the mixture obtained with the silver nitrate solution; after mixing the graphene oxide aqueous solution with the reduction agent, the graphene oxide is partially reduced by the reduction agent; the reduction agent should be excessively added, so as to completely reduce the silver ions. A stirring method is magnetic stirring or other stirring methods with same effect.

Preferably, the concentrations of the reduction agent and the silver nitrate solution are both 0.1-0.5 mol/L; a mass concentration of the graphene oxide aqueous solution is 0.7%-1.2%; the total content of the graphene oxide in the composite material is 0.5-6 wt %.

Preferably, in the step 3), the graphene oxide/silver suspension is washed for no less than 5 times, so as to completely remove the reduction agent and by-products; a freeze-drying period depends on a weight of the material to be dried, wherein the material should be completely dried.

Preferably, in the step 4), since oxygen-containing groups on a surface of the graphene oxide will hinder electrons transfer and reduce electrical conductivity of the composite material, it is necessary to treat the graphene oxide/silver composite powder with reduction process. During the process, the graphene oxide/silver composite powder is heated in a hydrogen atmosphere at 200-500° C. for 2-10 h, so as to obtain the graphene/silver composite powder.

Preferably, in the step 5), a powder metallurgy process comprises isostatic pressing and sintering, with an isostatic pressure of 0.5-5 GPa, a sintering temperature of 500-800° C., and a sintering time of 3-7 h.

Preferably, in the step 6), a hot-extruding temperature is 400-600° C., an extruding ratio is 20-60.

Preferably, in the step 7), a thickness of the graphene/silver composite belt material obtained by rolling is 0.1-1 mm. The reinforcement effect of graphene is significant.

The present invention also provides a graphene/silver composite material prepared by the above method.

Compared with conventional technologies, the graphene/silver composite material of the present invention adapts a different source of raw materials (or a combination of a preparation method of a matrix and a preparation method of an enhancement body is different). According to the present invention, the silver metal is prepared by chemical reduction, and the graphene oxide is direct composited. Furthermore, the reducing agents used are non-toxic and eco-friendly, and manufacturing and molding techniques used are powder metallurgy, hot-extruding and rolling.

According to the method of the present invention, the adding amount of the graphene oxide, and the shape and particle size of the silver matrix are easy to be controlled. Preferably, an adding amount of the graphene oxide is 0.5-6 wt % with a balance of silver; the silver powder prepared by reduction is spheroid with a particle size of 0.1-5 μm. The reinforcement effect of graphene is significant, which is able to meet different application requirements.

Compared with conventional technologies, the present invention has beneficial effects as follows:

(1) the silver matrix is creatively prepared by chemical reduction, which is directly composited with the graphene oxide for continuous production, wherein the composition effect is sufficient and graphene oxide is uniformly distributed;

(2) a part of particles in the silver matrix prepared by chemical reduction are in nano-scale, this part of silver nanoparticles also reinforces the composite material;

(3) freeze-drying is adapted for drying the in the graphene oxide/silver composite powder, which effectively prevent agglomeration and destruction of graphene;

(4) hydrogen is used for reduction of the graphene oxide/silver composite powder, so as to obtain the graphene/silver composite powder with uniformly distributed perfect graphene;

(5) during powder metallurgy process, the sintering process is carried out in the hydrogen atmosphere; on one hand, materials which is not thoroughly reduced in the composite powder is further reduced; on the other hand, the graphene structure is prevented from destruction;

(6) the graphene/silver composite material is further densified by hot-extruding technique, so as to obtain the graphene/silver composite wire material with excellent performance; and

(7) different types of graphene/silver composite wire materials are rolled to obtain the graphene/silver composite belt materials, wherein specifications of the composite belt materials are able to be adjusted according to specific needs. After rolling, the graphene is more orientation-distributed, and the reinforcing effect is improved.

According to the present invention, the chemical reduction method, the powder metallurgy technique, the hot-extruding technique, and the rolling technique cooperate with each other, so as to prepare the graphene/silver composite material with excellent properties, breaking a series of scientific problems and technical difficulties. According to the graphene/silver composite material of the present invention, a resistivity thereof is 1.5-1.7, with a relative conductivity IACS (International Annealed Copper Standard) of 106-108%; a density of 10.32-10.4 g/cm³; a Vickers hardness of 80-115; of tensile strength is 185-195 MPa; and an elongation of 40-45%.

### BRIEF DESCRIPTION OF THE DRAWINGS

FIG. 1 is a diagram of a method for preparing a graphene/silver composite material according to a preferred embodiment of the present invention.

### DETAILED DESCRIPTION OF THE PREFERRED EMBODIMENT

The embodiments of the present invention will be described in detail, and the following examples give a detailed description and a specific operation. However, the scope of the present invention is not limited to the following embodiments.

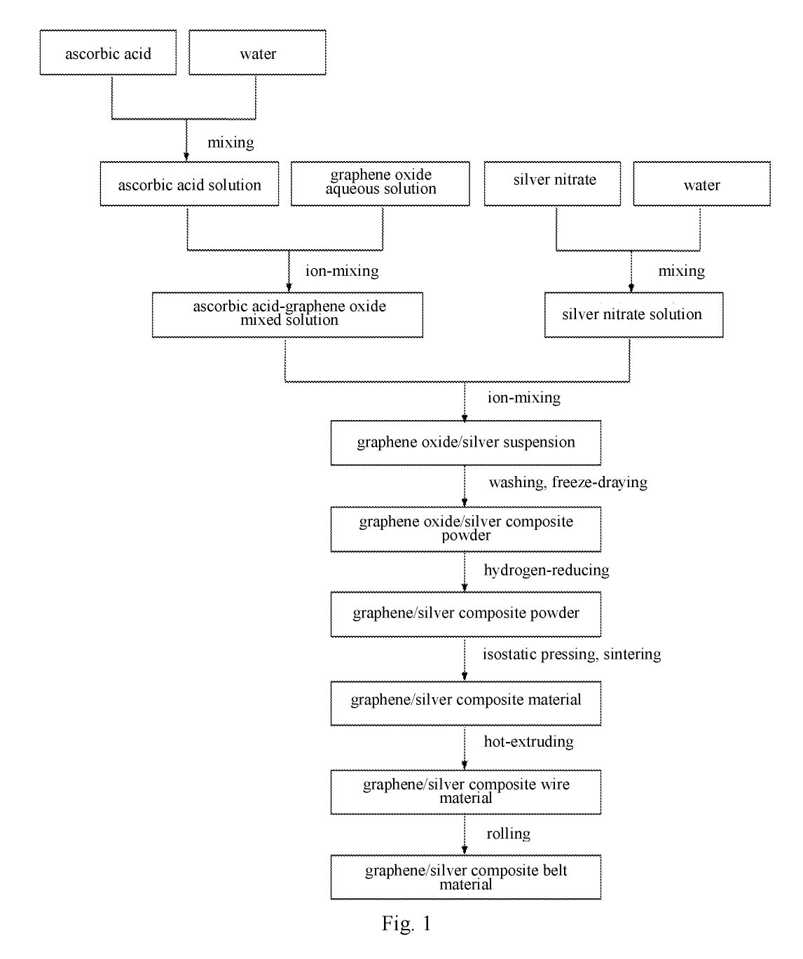

Referring to FIG. 1, a diagram of a method for preparing a graphene/silver composite material according to a preferred embodiment of the present invention is illustrated, wherein graphene/silver composite material is able to be prepared by executing processes in sequence, or selecting part of the processes according to application requirements.

### Embodiment 1

According to embodiment 1, basic operation processes for preparing the graphene/silver composite material are as follows:

I) Material Composition of the Graphene/Silver Composite Material

Main compounds of the graphene/silver composite material are silver metal and graphene. The silver metal is prepared by chemical reduction, which has a particle size of 0.1-5 μm and an amount of 94 wt % in the composite material. A graphene raw material is single-layer or few-layer graphene oxide prepared by a Hummers method, which has an amount of 6 wt % in the composite material.

II) Basic Steps for Preparing the Graphene/Silver Composite Material (as Shown in FIG. 1)

1) respectively preparing a 0.1 mol/L silver nitrate solution and a 0.1 mol/L ascorbic acid solution (or a solution selected form a group consisting of glucose, citric acid and oxalic acid);

2) adding graphene oxide into deionized water, and ion-mixing for 0.5 h, so as to evenly disperse the graphene oxide and obtain a graphene oxide solution with a concentration of 0.7%;

3) mixing 2.5 L the ascorbic acid solution with 183.6 g the graphene oxide solution, and ion-mixing for 5-10 min, then adding 2 L the silver nitrate solution into a mixture obtained and keeping ion-mixing; wherein silver nitrate is reduced to silver particles by ascorbic acid, and graphene oxide is adsorbed by silver powder, so as to form a graphene oxide/silver suspension;

4) centrifugal-washing the graphene oxide/silver suspension for 5-10 times, then freeze-drying for obtaining graphene oxide/silver composite powder;

5) pre-forming the graphene oxide/silver composite powder, then heating at 500° C. for 2 h with hydrogen atmosphere for reducing, so as to obtain graphene/silver composite powder; and

6) molding the graphene/silver composite powder by isostatic pressing techniques, so as to obtain the graphene/silver composite block material; sintering the block material in a sintering furnace at 700° C. for 5 h with the hydrogen atmosphere, so as to obtain the highly-densified graphene/silver composite material.

### Embodiment 2

Different from the embodiment 1, the embodiment 2 further adapts a hot-extruding step for obtaining a graphene/silver composite wire material.

According to embodiment 2, basic operation processes for preparing the graphene/silver composite wire material are as follows:

I) Material Composition of the Graphene/Silver Composite Wire Material

Main compounds of the graphene/silver composite material are silver metal and graphene. The silver metal is prepared by chemical reduction, which has a particle size of 0.1-5 μm and an amount of 97 wt % in the composite material. A graphene raw material is single-layer or few-layer graphene oxide prepared by a Hummers method, which has an amount of 3 wt % in the composite material.

II) Basic Steps for Preparing the Graphene/Silver Composite Wire Material (as Shown in FIG. 1)

1) respectively preparing a 0.25 mol/L silver nitrate solution and a 0.25 mol/L ascorbic acid solution;

2) adding graphene oxide into deionized water, and ion-mixing for 0.5 h, so as to evenly disperse the graphene oxide and obtain a graphene oxide solution with a concentration of 0.9%;

3) mixing 2.5 L the ascorbic acid solution with 178.5 g the graphene oxide solution, and ion-mixing for 5-10 min, then adding 2 L the silver nitrate solution into a mixture obtained and keeping ion-mixing; wherein silver nitrate is reduced to silver particles by ascorbic acid, and graphene oxide is adsorbed by silver powder, so as to form a graphene oxide/silver suspension;

4) centrifugal-washing the graphene oxide/silver suspension for 5-10 times, then freeze-drying for obtaining graphene oxide/silver composite powder;

5) pre-forming the graphene oxide/silver composite powder, then heating at 500° C. for 2 h with hydrogen atmosphere for reducing, so as to obtain graphene/silver composite powder;

6) molding the graphene/silver composite powder by isostatic pressing techniques, so as to obtain the graphene/silver composite block material; sintering the block material in a sintering furnace at 700° C. for 5 h with the hydrogen atmosphere; and

7) hot-extruding a highly-densified graphene/silver composite material obtained by powder metallurgy with an extruding temperature of 600° C. and an extruding ratio of 40, so as to obtain the graphene/silver composite wire material. After performance testing, it was found that a resistivity of the material is 1.52, a density is 10.32 g/cm³, a Vickers hardness is 100, a tensile strength is 192 MPa, and an elongation is 43%.

### Embodiment 3

Different from the embodiment 2, the embodiment 3 further adapts annealing and rolling steps for obtaining a graphene/silver composite belt material.

According to embodiment 3, basic operation processes for preparing the graphene/silver composite belt material are as follows:

I) Material Composition of the Graphene/Silver Composite Belt Material

Main compounds of the graphene/silver composite material are silver metal and graphene; wherein raw materials and amounts of the silver metal and the graphene are the same as the embodiment 2.

II) Basic Steps for Preparing the Graphene/Silver Composite Belt Material (as Shown in FIG. 1)

1) respectively preparing a 0.25 mol/L silver nitrate solution and a 0.25 mol/L ascorbic acid solution;

2) adding graphene oxide into deionized water, and ion-mixing for 0.5 h, so as to evenly disperse the graphene oxide and obtain a graphene oxide solution with a concentration of 0.9%;

3) mixing 2.5 L the ascorbic acid solution with 178.5 g the graphene oxide solution, and ion-mixing for 5-10 min, then adding 2 L the silver nitrate solution into a mixture obtained and keeping ion-mixing; wherein silver nitrate is reduced to silver particles by ascorbic acid, and graphene oxide is adsorbed by silver powder, so as to form a graphene oxide/silver suspension;

4) centrifugal-washing the graphene oxide/silver suspension for 5-10 times, then freeze-drying for obtaining graphene oxide/silver composite powder;

5) pre-forming the graphene oxide/silver composite powder, then providing reduction treatment, so as to obtain graphene/silver composite powder;

6) molding the graphene/silver composite powder by isostatic pressing techniques, so as to obtain the graphene/silver composite block material; sintering the block material in a sintering furnace at 700° C. for 5 h with the hydrogen atmosphere;

7) hot-extruding a highly-densified graphene/silver composite material obtained by powder metallurgy with an extruding temperature of 600° C. and an extruding ratio of 40, so as to obtain the graphene/silver composite wire material;

8) annealing the graphene/silver composite wire material at 350° C. for 2 h; and

9) rolling the annealed graphene/silver composite wire material with rolling techniques for obtaining the graphene/silver composite belt material with a thickness of 0.1 mm. After performance testing, it was found that a resistivity of the material is 1.51, a density is 10.34 g/cm³, a Vickers hardness is 115. Different from the embodiment 2, the resistivity of the graphene/silver composite material is slightly decreased after rolling, while the hardness is significantly increased.

### Embodiment 4

Different from the embodiment 3, the embodiment 4 adapts different mass proportions of a silver matrix and a graphene reinforcement body, so as to adjust process parameters according to different formulation.

According to embodiment 4, basic operation processes for preparing a graphene/silver composite material are as follows:

I) Material Composition of the Graphene/Silver Composite Belt Material

Main compounds of the graphene/silver composite material are silver metal and graphene. The silver metal is prepared by chemical reduction, which has a particle size of 0.1-5 μm and an amount of 99.5 wt % in the composite material. A graphene raw material is single-layer or few-layer graphene oxide prepared by a Hummers method, which has an amount of 0.5 wt % in the composite material.

II) Basic Steps for Preparing the Graphene/Silver Composite Material (as Shown in FIG. 1)

1) respectively preparing a 0.5 mol/L silver nitrate solution and a 0.5 mol/L ascorbic acid solution;

2) adding graphene oxide into deionized water, and ion-mixing for 0.5 h, so as to evenly disperse the graphene oxide and obtain a graphene oxide solution with a concentration of 1.2%;

3) mixing 2.5 L the ascorbic acid solution with 44.6 g the graphene oxide solution, and ion-mixing for 5-10 min, then adding 2 L the silver nitrate solution into a mixture obtained and keeping ion-mixing; wherein silver nitrate is reduced to silver particles by ascorbic acid, and graphene oxide is adsorbed by silver powder, so as to form a graphene oxide/silver suspension;

4) centrifugal-washing the graphene oxide/silver suspension for 5-10 times, then freeze-drying for obtaining graphene oxide/silver composite powder;

5) pre-forming the graphene oxide/silver composite powder, t then heating at 350° C. for 5 h with hydrogen atmosphere for reducing, so as to obtain graphene/silver composite powder;

6) molding the graphene/silver composite powder by isostatic pressing techniques, so as to obtain the graphene/silver composite block material; sintering the block material in a sintering furnace at 800° C. for 5 h with the hydrogen atmosphere;

7) hot-extruding a highly-densified graphene/silver composite material obtained by powder metallurgy with an extruding temperature of 400° C. and an extruding ratio of 20, so as to obtain the graphene/silver composite wire material; wherein after performance testing, it was found that a resistivity of the material is 1.6, a density is 10.37 g/cm³, a Vickers hardness is 80, a tensile strength is 185 MPa, and an elongation is 42%; different from the embodiment 2, the Vickers hardness and the tensile strength are slightly decreased after decreasing the amount of the graphene;

8) annealing the graphene/silver composite wire material at 380° C. for 2 h; and

9) rolling the annealed graphene/silver composite wire material with rolling techniques for obtaining the graphene/silver composite belt material with a thickness of 0.5 mm. After performance testing, it was found that a resistivity of the material is 1.55, a density is 10.37 g/cm³, a Vickers hardness is 110. The resistivity of the graphene/silver composite material is slightly decreased after rolling, while the hardness is significantly increased.

It should be understood that the above-described embodiments are merely part of all embodiments of the present invention. According to the present invention, the graphene/silver composite material includes all applicable forms, such as changing a preparation formulation of the silver matrix, and other combinations of silver salts and reducing agent solutions. The formulation of the final composite material should be designed based on application requirements.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1-10. (canceled)

11. A method for preparing a graphene/silver composite material, comprising steps of:
1) preparing a silver nitrate solution and a reduction agent, respectively;
2) mixing the reduction agent with a graphene oxide aqueous solution, then adding the silver nitrate solution while stirring; wherein silver nitrate is reduced to silver micro-particles and a small amount of nano-particles, and graphene oxide is adsorbed by the silver particles, so as to form a graphene oxide/silver suspension;
3) washing the graphene oxide/silver suspension obtained in the step 2) for several times by centrifugation method, then freeze-drying to obtain graphene oxide/silver composite powder;
4) preforming the graphene oxide/silver composite powder obtained in the step 3), then reducing in hydrogen to obtain graphene/silver composite powder; and
5) molding and sintering the graphene/silver composite powder obtained in the step 4) by powder metallurgy techniques, so as to obtain the graphene/silver composite material.

12. The method, as recited in claim 11, wherein in the step 1), the reduction agent is selected from a group consisting of ascorbic acid, glucose, citric acid and oxalic acid.

13. The method, as recited in claim 11, wherein in the step 2), the graphene oxide is single-layer or few-layer graphene oxide prepared by a Hummers method; a mixing order of the graphene oxide aqueous solution, the reduction agent and the silver nitrate solution is: mixing the graphene oxide aqueous solution with the reduction agent, then mixing a mixture obtained with the silver nitrate solution; after mixing the graphene oxide aqueous solution with the reduction agent, the graphene oxide is partially reduced by the reduction agent; the reduction agent is excessively added, so as to completely reduce silver ions.

14. The method, as recited in claim 13, wherein a concentration of the reduction agent and a concentrate of the silver nitrate solution are both 0.1-0.5 mol/L; a mass concentration of the graphene oxide aqueous solution is 0.7-1.2%; a total content of the graphene oxide in the composite material is 0.5-6 wt %.

15. The method, as recited in claim 11, further comprising a step 6) after the step 5): extruding the graphene/silver composite material obtained in the step 5) by hot-extruding technique and charcoal protection which prevents oxidization, wherein the material is further densified to form a graphene/silver composite wire.

16. The method, as recited in claim 12, further comprising a step 6) after the step 5): extruding the graphene/silver composite material obtained in the step 5) by hot-extruding technique and charcoal protection which prevents oxidization, wherein the material is further densified to form a graphene/silver composite wire.

17. The method, as recited in claim 13, further comprising a step 6) after the step 5): extruding the graphene/silver composite material obtained in the step 5) by hot-extruding technique and charcoal protection which prevents oxidization, wherein the material is further densified to form a graphene/silver composite wire.

18. The method, as recited in claim 14, further comprising a step 6) after the step 5): extruding the graphene/silver composite material obtained in the step 5) by hot-extruding technique and charcoal protection which prevents oxidization, wherein the material is further densified to form a graphene/silver composite wire.

19. The method, as recited in claim 15, further comprising a step 7) after the step 6): rolling the graphene/silver composite wire obtained in the step 6) by rolling technique, so as to obtain graphene/silver composite belt, wherein the graphene is further orientation-distributed in the silver matrix, which improves a reinforcement effect of graphene.

20. The method, as recited in claim 16, further comprising a step 7) after the step 6): rolling the graphene/silver composite wire obtained in the step 6) by rolling technique, so as to obtain graphene/silver composite belt, wherein the graphene is further orientation-distributed in the silver matrix, which improves a reinforcement effect of graphene.

21. The method, as recited in claim 17, further comprising a step 7) after the step 6): rolling the graphene/silver composite wire obtained in the step 6) by rolling technique, so as to obtain graphene/silver composite belt, wherein the graphene is further orientation-distributed in the silver matrix, which improves a reinforcement effect of graphene.

22. The method, as recited in claim 18, further comprising a step 7) after the step 6): rolling the graphene/silver composite wire obtained in the step 6) by rolling technique, so as to obtain graphene/silver composite belt, wherein the graphene is further orientation-distributed in the silver matrix, which improves a reinforcement effect of graphene.

23. The method, as recited in claim 19, wherein in the step 6), a hot-extruding temperature is 400-600° C., an extruding ratio is 20-60; in the step 7), a thickness of the graphene/silver composite belt material obtained by rolling is 0.1-1 mm.

24. The method, as recited in claim 20, wherein in the step 6), a hot-extruding temperature is 400-600° C., an extruding ratio is 20-60; in the step 7), a thickness of the graphene/silver composite belt material obtained by rolling is 0.1-1 mm.

25. The method, as recited in claim 21, wherein in the step 6), a hot-extruding temperature is 400-600° C., an extruding ratio is 20-60; in the step 7), a thickness of the graphene/silver composite belt material obtained by rolling is 0.1-1 mm.

26. The method, as recited in claim 22, wherein in the step 6), a hot-extruding temperature is 400-600° C., an extruding ratio is 20-60; in the step 7), a thickness of the graphene/silver composite belt material obtained by rolling is 0.1-1 mm.

27. The method, as recited in claim 11, wherein an adding amount of the graphene oxide is 0.5-6 wt % with a balance of silver; the silver powder prepared by reduction is spheroid with a particle size of 0.1-5 μm.

28. The method, as recited in claim 12, wherein an adding amount of the graphene oxide is 0.5-6 wt % with a balance of silver; the silver powder prepared by reduction is spheroid with a particle size of 0.1-5 μm.

29. The method, as recited in claim 13, wherein an adding amount of the graphene oxide is 0.5-6 wt % with a balance of silver; the silver powder prepared by reduction is spheroid with a particle size of 0.1-5 μm.

30. The method, as recited in claim 14, wherein an adding amount of the graphene oxide is 0.5-6 wt % with a balance of silver; the silver powder prepared by reduction is spheroid with a particle size of 0.1-5 μm.

31. A graphene/silver composite material prepared by a method as recited in claim 11.

32. A graphene/silver composite material prepared by a method as recited in claim 26.

33. The graphene/silver composite material, as recited in claim 31, wherein a resistivity thereof is 1.5-1.7, a relative conductivity IACS (International Annealed Copper Standard) is 106-108%; a density is 10.32-10.4 g/cm³; a Vickers hardness is 80-115; a tensile strength is 185-195 MPa; and an elongation is 40-45%.

34. The graphene/silver composite material, as recited in claim 32, wherein a resistivity thereof is 1.5-1.7, a relative conductivity IACS (International Annealed Copper Standard) is 106-108%; a density is 10.32-10.4 g/cm³; a Vickers hardness is 80-115; a tensile strength is 185-195 MPa; and an elongation is 40-45%.
